(19) United States
(12) Patent Application Publication
(10) Pub. No.: US 2009/0016966 A1
(43) Pub. Date: Jan. 15, 2009

(54) Air-Freshening Device

(75) Inventors: Janice Anson, Hull (GB); Ian Keppie, Hull (GB); Malcolm Tom McKechnie, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough, Berkshire (GB)

(21) Appl. No.: 12/096,437

(22) PCT Filed: Oct. 30, 2006
(86) PCT No.: PCT/GB06/04049

§ 371 Date: Jun. 23, 2008

(30) Foreign Application Priority Data
Dec. 16, 2005 (GB) 0525592.2

(51) Int. Cl. A01N 25/02

(52) U.S. Cl. 424/43

(57) ABSTRACT

A sprayable air-freshening composition comprising active particles for removing malodours, said active particles comprising at least one metal supported on a solid particulate support, wherein the at least one metal is selected from Groups 3 to 12 and the Lanthanide series of the periodic table.

The present invention relates to a sprayable air-freshening composition comprising active particles for removing malodours. The present invention also relates to active particles for removing malodours.

Air-fresheners or deodorizers are used in many households to impart fragrances to the ambient air. Various types of devices are known for the diffusion of volatile air-freshening compositions into the surroundings. For example, spray devices, such as aerosol sprays, may be used to dispense a liquid air-freshening composition into the ambient air.

Most air-freshening compositions contain fragrances, which mask bad odours so that they are less easily perceived. However, to mask particularly strong odours, high concentrations of fragrance are required. Many consumers find high concentrations of fragrance to be overpowering or sickly. Accordingly, there is a need to provide an efficient means for reducing or removing malodours from the atmosphere.

According to a first aspect of the present invention, there is provided a sprayable air-freshening composition comprising active particles for removing malodours, said active particles comprising at least one metal supported on a solid particulate support, wherein the at least one metal is selected from Groups 3 to 12 and the Lanthanide series of the periodic table.

The active particles employed in the present invention are capable of binding or reacting with malodorous compounds in the atmosphere, so that these compounds can no longer be readily released back into the atmosphere.

Without wishing to be bound by any theory, it is believed that the active particles react or interact with the chemical compounds responsible for the malodour. For example, the metal in the active particles may react with sulphur groups in the malodorous compounds to form sulphide bonds. Alternatively or additionally, the active particles may catalyse the oxidation or reduction of the malodorous compounds to form involatile or non-odorous compounds.

Metals selected from groups 3 to 12 of the periodic table are also known as transition metals. Where a transition metal is used, a transition metal from group 7 to 12 of the periodic table is preferred. More preferably, the transition metal is selected from groups 7, 10 or 11 of the periodic table. Suitable metals include Mn, Tc, Re, Ni, Pd, Pt, Cu, Ag and Au. In a preferred embodiment, the metal is selected from at least one of silver, palladium, manganese, gold and copper. Silver is especially preferred. Silver may be used on its own or in combination with at least one other metal. Suitable combinations include Ag/Pd and Ag/Mn/Cu.

Where a metal from the lanthanide series is employed, cerium is preferred.

The metal may be used in metallic form or as a metal compound. For example, the metal may be in the form of an oxide or a metal salt.

The metal may form 0.1 to 30 weight % of the total weight of the active particles. Preferably, the metal forms 0.5 to 20 weight %, more preferably 1 to 10 weight %, even more preferably 1 to 3 weight %, for example, 1, 2 or 3 weight % of the total weight of the active particles.

The metal may be deposited on the support in any suitable way. For example, the metal may be deposited on the surface of the support and/or distributed throughout the support. Any suitable method may be employed to deposit the metal on the support. For example, the support particles may be coated with a solution of the metal salt(s). Alternatively, the support may be impregnated in a solution of the metal salt(s). Typically, the support is treated with a solution of the metal salt(s) and then heated to form deposits of the metal on and in the structure of the support (e.g. by thermal reduction). Alternatively, after the support is treated with a solution of the metal salt(s), a chemical reducing agent may be added to form deposits of the metal on and in the structure of the support.

Any suitable support may be used in the composition of the present invention. For example, inorganic supports may be used. The support is preferably porous. Suitable supports include silicates, zeolites, vermiculite, metal oxides, clays, carbon and metal carbonates. Zeolite supports are preferred. Using a combination of supports with differing porosities may improve performance.

The support may form 0.1 to 99.9 weight % of the total weight of the active particles. Preferably, the support forms 0.5 to 98 weight %, more preferably 2 to 95 weight %, even more preferably 5 to 90 weight % of the total weight of the active particles. In one embodiment, the support forms 50 to 85 weight %, for example 60 to 80 weight % of the total weight of the active particles.

The support may assist in the removal of malodours from the atmosphere, for example, by absorption and adsorption

The active particles employed in the present invention may further include a base. The base is capable of reacting with acidic species, such as isovaleric acid, hexanoic acid, butyric acid, n-caproic acid, thioglycolic acid, propionic acid, acetic acid, capric acid and caproic acid.

Any suitable base may be employed. Suitable examples include oxides, carbonates and hydrogencarbonates. For example, oxides, carbonates and hydrogencarbonates of alkali or alkaline earth metals may be used. Examples of suitable bases include magnesium oxide and calcium oxide. Magnesium oxide is preferred.

The base may be present at an amount of 0.5 to 30 wt % based on the total weight of the active particles. Preferably, the base is present in an amount of 1 to 20 weight %, more preferably 5 to 10 weight % based on the total weight of the active particles.

The base is preferably in particulate form. Particles of the base may be mixed with particles of the support before addition of the metal (e.g. metal salt(s)) so that the metal is distributed across the support and base particles.

The active particles may also include silica. The silica may be in particulate form. Silica may form 5 to 50 weight %, preferably 10 to 30 weight %, for example 20 weight % of the total weight of the active particles.

The active particles may have a mean particle size in the range of 0.1 to 200 microns, more preferably 5 to 100 microns, most preferably 10 to 50 microns.

In one embodiment of the present invention, the active particles comprise

0.1 to 10 wt % of silver, palladium, manganese and/or copper;

a zeolite support; and

0.5 to 30 wt % of an alkaline or alkaline earth metal oxide.

In a more preferred embodiment, the active particles comprise

2 to 5 wt % of silver;

a zeolite support; and

5 to 25 wt % of magnesium oxide.

The active particles may form 0.1 to 30 weight %, preferably 0.5 to 10 weight %, for example, 1 to 5 weight % of the sprayable composition.

The sprayable composition of the present invention may include a solvent. The solvent may help to dissolve malodorous compounds facilitating their removal by the active particles. Suitable solvents include water and alcohols. Suitable alcohols include C₁ to C₄ alcohols, such as methanol, ethanol, propanol (e.g. n-propanol and i-propanol) and butanol (e.g. n-butanol and t-butanol). Glycols, such as propylene glycol and triethylene glycol, may be used.

The solvent may form 50 up to 100 weight %, preferably 60 to 90 weight %, for example 70 to 80 weight % of the sprayable composition.

The sprayable composition may include a fragrance. The fragrance may be one or more volatile organic compounds which are available from perfumery suppliers such as Firmenich Inc., Takasago Inc., Noville Inc., Quest Co., International Flavors & Fragrances, and Givaudan-roure corp.

A wide variety of chemicals are known for perfumery, such as aldehydes, ketones, esters, alcohols, terpenes, and the like. Most conventional fragrance materials are volatile essential oils. A fragrance can be relatively simple in composition, or can be a complex mixture of natural and synthetic chemical components.

Natural fragrances include naturally derived oils such as oil of bergamot, bitter orange, lemon, mandarin, caraway, cedar leaf, clove leaf, cedar wood, geranium, lavender, orange, origanum, petitgrain, white cedar, patchouli, lavandin, neroli, rose absolute, and the like. Natural perfumes include the extracts of blossoms, stems and leaves, fruits, fruit peel, roots, woods, herbs and grasses, needles and branches, resins and balsams. Other suitable perfume oils are essential oils of relatively low volatility which are mostly used as aroma components. Examples are sage oil, chamomile oil, clove oil, melissa oil, mint oil, cinnamon leaf oil, lime-blossom oil, juniper berry oil, vetivert oil, olibanum oil, galbanum oil, ladanum oil and lavendin oil.

Typical synthetic perfume compounds are products of the ester, ether, aldehyde, ketone, alcohol and hydrocarbon type. Examples of perfume compounds of the ester type are benzyl acetate, p-tert.butyl cyclohexylacetate, linalyl acetate, phenyl ethyl acetate, linalyl benzoate, benzyl formate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal. Examples of suitable ketones are the ionones and methyl cedryl ketone. Suitable alcohols are anethol, citronellol, eugenol, isoeugenol, geraniol, linalool, phenylethyl alcohol and terpineol. The hydrocarbons mainly include the terpenes and balsams.

Synthetic types of fragrance compositions either alone or in combination with natural oils are described in U.S. Pat. Nos. 4,324,915; 4,411,829; and 4,434,306; incorporated herein by reference. Other artificial liquid fragrances include geraniol, geranyl acetate, eugenol, isoeugenol, linalool, linalyl acetate, phenethyl alcohol, methyl ethyl ketone, methylionone, isobomyl acetate, and the like.

It is, however, preferred to use mixtures of different perfume compounds which, together, produce an agreeable fragrance.

The following are also preferably used either individually or in the form of mixtures: dihydromyrcenol, lilial, lyral, citronellol, phenylethyl alcohol, α-hexylcinnamaldehyde, benzyl acetone, cyclamen aldehyde, linalool, boisambrene forte, ambroxan, indole, hedione, sandelice, citrus oil, mandarin oil, orange oil, allylamyl glycolate, cyclovertal, lavendin oil, clary oil, β-damascone, geranium oil bourbon, cyclohexyl salicylate, vertofix coeur, iso-e-super, fixolide np, evernyl, iraldein gamma, phenylacetic acid, benzyl acetate, rose oxide, romillat, irotyl and floramat.

The fragrance may be present in the sprayable composition in an amount of 0.01 to 20 weight %, preferably 0.1 to 10 weight %, more preferably 0.2 to 5 weight %.

The sprayable composition may also comprise up to 10 weight % of further adjuvants and/or excipients, such as but not restricted to corrosion inhibitors, preservatives, biocides, ph modifiers and buffers, surfactants, oil components, emulsifiers, stabilizers, polymers, silicone compounds, antioxidants, film formers, solubilizers, preservatives, dyes and the like.

The sprayable composition is liquid.

The sprayable composition is preferably an aerosol composition. An aerosol is a term used to identify a large number of products which are dispensed as a mist, stream, spray or even a foam. Pressurised cans are the typical vehicle for the formation of aerosols, providing a low cost, easy to use method of dispensing such products. A pressurised propellant is used to provide a force sufficient to discharge the liquid product from the container. The user then actuates the aerosol dispenser by for example pressing an actuator button.

The sprayable composition of the present invention may include a propellant. Any suitable propellant may be employed. Preferably, a liquefied gas-type propellant is used. Suitable propellants include butane, carbon dioxide, nitrogen and/or compressed air. It is common to use a blend of propellant components to achieve best combination of solubility, economics, pressure and safety.

The propellant may form 5 to 40 weight %, preferably 10 to 35 weight %, for example 15 to 30 weight % of the sprayable composition. In one embodiment, 20 to 25 weight % of propellant is present in the sprayable composition.

Where the sprayable composition is an aerosol composition, the aerosol composition may be prepared by introducing the sprayable composition into the container, together with a propellant, together with a propellant to a pressure approximately equal to, or greater than, the vapour pressure of the propellant. Thus filled, the container still has a certain amount of space that is not occupied by liquid. This space is referred to as the “head space” of the dispenser assembly. Since the container is pressurized to approximately the vapour pressure of the propellant, some of the propellant is dissolved or emulsified in the liquid product. The remainder of the propellant is in the vapour phase and fills the head space. As the product is dispensed, the pressure in the container remains approximately constant as liquid propellant evaporates to replenish discharged vapour. Liquefied gas propellants keep the pressure constant in the aerosol can until the contents are exhausted, thus ensuring a consistent spray performance throughout the lifetime of the can.

According to a second aspect of the present invention, there are provided active particles for removing malodours comprising a base and at least one metal supported on a solid particulate support, wherein

the at least one metal is selected from silver, palladium, manganese, copper, gold and cerium,

the support is selected from at least one of silicates, zeolites, vermiculite, metal oxides, clays, carbon and metal carbonates; and

the base is selected from alkaline or alkaline earth metal oxides, carbonates, hydrogencarbonates.

For the avoidance of doubt, the preferred and optional features described in relation to the active particles employed in the first aspect of the present invention can be equally applied to the active particles of the second aspect of the present invention.

These and other aspects of the present invention will now be described with reference to the following examples.

### EXAMPLES

The following procedure was used to assess the performance of various air-freshening compositions against particular malodours. The procedure was carried out in triplicate per composition and malodour.

Step 1. Three 200 litre enclosures were prepared as follows:

Enclosure 1: Malodour Only

Enclosure 2: Composition Only

Enclosure 3: Malodour+Composition

The following synthetic malodours were used: tobacco, bathroom, kitchen, pet, mould and mildew and garbage.

All air-freshening compositions were administered in aerosol form.

Step 2. 16 trained panelists assessed the level of malodour in the enclosures using a 0-10 scale, where 0=no malodour and 10=very strong malodour.

Step 3. The percentage reduction in malodour for each replicate was calculated using the following equation:

Percentage Reduction=((Malodour Rating Enclosure 1−Enclosure 3)/(Malodour Rating Enclosure 1−Enclosure 2))×100%

Step 4. The average percentage reduction in malodour over the three replicates was calculated

### Example 1

In this Example, the following air-freshening composition was tested for its performance against a synthetic bathroom malodour:

| | |
|---|---|
| 67.84% | Deionised Water |
| 0.09% | Sodium Nitrite |
| 0.07% | Sodium Bicarbonate |
| 5% | Triethylene glycol |
| 25% | Butane Gas |
| 2% | Active particles |

The composition of the active particles was as follows:

| | |
|---|---|
| 68% | Zeolite |
| 20% | Silica |
| 2% | Silver, deposited by thermal |
| | reduction of silver nitrate |
| 10% | Magnesium oxide |

The percentage reduction in bathroom malodour was 57%.

### Example 2

In this Example, the following air-freshening composition was tested for its performance against a synthetic bathroom malodour:

| | |
|---|---|
| 67.84% | Deionised Water |
| 0.09% | Sodium Nitrite |
| 0.07% | Sodium Bicarbonate |
| 5% | Triethylene glycol |
| 25% | Butane Gas |
| 2% | Active particles |

The composition of the active particles was as follows:

| | |
|---|---|
| 78% | Zeolite |
| 2% | Silver, deposited by thermal |
| | reduction of silver nitrate |
| 20% | Magnesium oxide |

The percentage reduction in bathroom malodour was 57%.

### Example 3

In this Example, the following air-freshening composition was tested for its performance against a synthetic bathroom malodour:

| | |
|---|---|
| 67.84% | Deionised Water |
| 0.09% | Sodium Nitrite |
| 0.07% | Sodium Bicarbonate |
| 5% | Triethylene glycol |
| 25% | Butane Gas |
| 2% | Active particles |

The composition of the active particles was as follows:

| | |
|---|---|
| 87% | Zeolite |
| 3% | Silver, deposited by thermal |
| | reduction of silver nitrate |
| 10% | Magnesium oxide |

The percentage reduction in bathroom malodour was 39%.

### Example 4

In this Example, the following air-freshening composition was tested for its performance against a synthetic kitchen malodour:

| | |
|---|---|
| 67.84% | Deionised Water |
| 0.09% | Sodium Nitrite |
| 0.07% | Sodium Bicarbonate |
| 5% | Triethylene glycol |
| 25% | Butane Gas |
| 2% | Active particles |

The composition of the active particles was as follows:

| | |
|---|---|
| 95% | Zeolite |
| 2.5% | Silver, deposited by thermal |
| | reduction of silver nitrate |
| 2.5% | Palladium |

The percentage reduction in bathroom malodour was 61%.

1. A sprayable air-freshening composition comprising active particles for removing malodours, said active particles comprising at least one metal supported on a solid particulate support, wherein the at least one metal is selected from Groups 3 to 12 and the Lanthanide series of the periodic table.

2. A composition as claimed in claim 1, wherein the metal is selected from at least one of silver, palladium, manganese, copper, gold and cerium.

3. A composition as claimed in any one of the preceding claims, wherein the metal is silver.

4. A composition as claimed any one of the preceding claims, wherein the metal is in the form of an oxide.

5. A composition as claimed in any one of the preceding claims, wherein the support is porous.

6. A composition as claimed in any one of the preceding claims, wherein the support is inorganic.

7. A composition as claimed claim 6, wherein the support is selected from at least one of silicates, zeolites, vermiculite, metal oxides, clays, carbon and metal carbonates.

8. A composition as claimed in any one of the preceding claims, wherein the metal is present at a level of 0.1 to 30 weight % based on the total weight of the active particles.

9. A composition as claimed any one of the preceding claims, wherein the active particles also include a base.

10. A composition as claimed in claim 9, wherein the base is in the form of solid particles.

11. A composition as claimed in any claim 9 or 10, wherein the base is present in an amount of 0.5 to 30 weight % based on the total weight of the active particles.

12. A composition as claimed in any one of claims 9 to 12, wherein the base is selected from at least one of alkaline or alkaline earth metal oxides, carbonates and hydrogencarbonates.

13. A composition as claimed in claim 10, wherein the base is magnesium oxide.

14. A composition as claimed in claim 1, wherein the active particles comprise
0.1 to 10 wt % of silver, palladium, manganese and/or copper;
a zeolite support; and
0.5 to 30 wt % of an alkaline or alkaline earth metal oxide.

15. A composition according to claim 14, wherein the active particles comprise:
2 to 5 wt % of silver;
a zeolite support; and
5 to 25 wt % of magnesium oxide.

16. A composition as claimed in any one of the preceding claims, wherein the active particles have a mean particle size in the range of 0.1 to 100 microns.

17. A composition as claimed in claim 16, wherein the active particles have a mean particle size of 10 to 30 microns.

18. A composition as claimed in any one of the preceding claims, further comprising a solvent preferably selected from water, ethanol, propylene glycol and triethylene glycol.

19. A composition as claimed in any one of the preceding claims, further comprising a fragrance.

20. A composition as claimed in any one of the preceding claims, further comprising a propellant.

21. A composition as claimed in any one of the preceding claims, which comprises
0.5 to 5% active particles,
0.5 to 10% solvent, and
10 to 35% propellant.

22. A composition as claimed in any claim 20 or 21, wherein the propellant is butane, carbon dioxide, nitrogen and/or compressed air.

23. The use of a composition as claimed in any one of claims 1 to 22 to remove malodours from the atmosphere.

24. The use of as claimed in claim 23 wherein the use is performed in the atmosphere in or around a toilet.

25. A method of removing malodours from the atmosphere, which comprises spraying a composition as claimed in any one of claims 1 to 22 into the atmosphere as an aerosol.

26. An aerosol container comprising a composition according to any of claims 1 to 22.

27. Active particles for removing malodours comprising a base and at least one metal supported on a solid particulate support, wherein
the at least one metal is selected from silver, palladium, manganese, copper, gold and cerium,
the support is selected from at least one of silicates, zeolites, vermiculite, metal oxides, metal carbonates; and
the base is selected from alkaline or alkaline earth metal oxides, carbonates, hydrogencarbonates.

28. The use of active particles according to claim 27 to remove malodours from the atmosphere.
